(19) United States
(12) Patent Application Publication
(10) Pub. No.: US 2026/0066966 A1
(43) Pub. Date: Mar. 5, 2026

(54) DATA TRANSMISSION AT SCELL ACTIVATION

(71) Applicant: Nokia Technologies Oy, Espoo (FI)

(72) Inventors: Lei DU, Beijing (CN); Lars DALSGAARD, Oulu (FI); Daejung YOON, Massy (FR)

(21) Appl. No.: 19/101,089

(22) PCT Filed: Aug. 5, 2022
(86) PCT No.: PCT/CN2022/110652

§ 371 Date: Feb. 4, 2025

(51) Int. Cl. H04B 7/06; H04L 5/00

(52) U.S. Cl. CPC H04B 7/0617; H04B 7/0632; H04L 5/0096

(57) ABSTRACT

Embodiments of the present disclosure relate to data transmission at SCell activation. A terminal device determines that a first data transmission in a secondary cell provided by a network device is possible during an activation procedure of the secondary cell. Then, the terminal device transmits, to the network device, a first beam report of one or more transmit beams for the secondary cell. Moreover, the terminal device receives, from the network device, scheduling of the first data transmission in the secondary cell. As a result, the efficiency of data transmission at secondary cell (SCell) activation may be improved.

### FIELD

Various example embodiments relate to the field of telecommunication and in particular, to methods, devices, apparatuses, and computer readable storage media for data transmission at secondary cell (SCell) activation.

### BACKGROUND

In a communication system, such as New Radio (NR) and Long Term Evolution (LTE), an SCell can be activated or deactivated to enable reasonable User Equipment (UE) battery consumption when Carrier Aggregation (CA) is configured. The transition between an activated state and a deactivated state may be based on Medium Access Control (MAC) Control Element (CE) commands from a network device. For example, the SCell activation/deactivation MAC CE commands from the network device may indicate to the UE whether an SCell shall be activated or deactivated.

When a UE receives an activation command to activate a deactivated SCell, it takes activation time, i.e. activation delay, to transit from the deactivated state to the activated state. The activation delay required by the UE may be varied depending on several factors such as whether the SCell is known or unknown, whether the SCell belongs to Frequency Band 1 (FR1) or Frequency Band 2 (FR2), etc. However, how to reduce the impact caused by the activation delay needs to be studied and developed.

### SUMMARY

In general, example embodiments of the present disclosure provide a solution for data transmission at SCell activation.

In a first aspect, there is provided a terminal device. The terminal device comprises at least one processor and at least one memory storing instructions that, when executed by the at least one processor, cause the terminal device at least to: determine that a first data transmission in a secondary cell provided by a network device is possible during an activation procedure of the secondary cell; transmit, to the network device, a first beam report of one or more transmit beams for the secondary cell; and receive, from the network device, scheduling of the first data transmission in the secondary cell.

In a second aspect, there is provided a network device. The network device comprises at least one processor and at least one memory storing instructions that, when executed by the at least one processor, cause the network device at least to: receive, from the terminal device, a first beam report of one or more transmit beams for a secondary cell provided by the network device; transmit, to the terminal device, a first indication of at least one transmit beam for the secondary cell, the at least one transmit beam being determined based on the first beam report and used for scheduling of a first data transmission in the secondary cell; and transmit, to the terminal device in the secondary cell, the first data transmission based on the scheduling of the first data transmission during an activation procedure of the secondary cell.

In a third aspect, there is provided a method implemented at a terminal device. The method comprises determining that a first data transmission in a secondary cell provided by a network device is possible during an activation procedure of the secondary cell; transmitting, to the network device, a first beam report of one or more transmit beams for the secondary cell; and receiving, from the network device, scheduling of the first data transmission in the secondary cell.

In a fourth aspect, there is provided a method implemented at a network device. The method comprises receiving, from the terminal device, a first beam report of one or more transmit beams for a secondary cell provided by the network device; transmitting, to the terminal device, a first indication of at least one transmit beam for the secondary cell, the at least one transmit beam being determined based on the first beam report and used for scheduling of a first data transmission in the secondary cell; and transmitting, to the terminal device in the secondary cell, the first data transmission based on the scheduling of the first data transmission during an activation procedure of the secondary cell.

In a fifth aspect, there is provided an apparatus. The apparatus comprises means for determining, at a terminal device, that a first data transmission in a secondary cell provided by a network device is possible during an activation procedure of the secondary cell; means for transmitting, to the network device, a first beam report of one or more transmit beams for the secondary cell; and means for receiving, from the network device, scheduling of the first data transmission in the secondary cell.

In a sixth aspect, there is provided an apparatus. The apparatus comprises means for receiving, at a network device, from the terminal device, a first beam report of one or more transmit beams for a secondary cell provided by the network device; means for transmitting, to the terminal device, a first indication of at least one transmit beam for the secondary cell, the at least one transmit beam being determined based on the first beam report and used for scheduling of a first data transmission in the secondary cell; and means for transmitting, to the terminal device in the secondary cell, the first data transmission based on the scheduling of the first data transmission during an activation procedure of the secondary cell.

In a seventh aspect, there is provided a non-transitory computer readable medium comprising program instructions for causing an apparatus to perform at least the method according to any one of the above third to fourth aspect.

In an eighth aspect, there is provided a computer program comprising instructions, which, when executed by an apparatus, cause the apparatus at least to perform at least the method according to any one of the above third to fourth aspect.

In a ninth aspect, there is provided a terminal device. The terminal device comprises determining circuitry configured to determine that a first data transmission in a secondary cell provided by a network device is possible during an activation procedure of the secondary cell; transmitting circuitry configured to transmit, to the network device, a first beam report of one or more transmit beams for the secondary cell; and receiving circuitry configured to receive, from the network device, scheduling of the first data transmission in the secondary cell.

In a tenth aspect, there is provided a network device. The network device comprises receiving circuitry configured to receive, from the terminal device, a first beam report of one or more transmit beams for a secondary cell provided by the network device; first transmitting circuitry configured to transmit, to the terminal device, a first indication of at least one transmit beam for the secondary cell, the at least one transmit beam being determined based on the first beam report and used for scheduling of a first data transmission in the secondary cell; and second transmitting circuitry configured to transmit, to the terminal device in the secondary cell, the first data transmission based on the scheduling of the first data transmission during an activation procedure of the secondary cell.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A illustrates an example environment in which example embodiments of the present disclosure can be implemented;

FIG. 1B illustrates a schematic diagram of beamforming at network device and terminal device sides according to some embodiments of the present disclosure;

FIG. 2 illustrates a signaling flow between the terminal device and the network device according to some example embodiments of the present disclosure;

FIG. 3 illustrates an example process of enabling early data transmission at SCell activation according to some embodiments of the present disclosure;

FIG. 4 illustrates another example process of enabling early data transmission at SCell activation according to some other embodiments of the present disclosure;

FIG. 5 illustrates a flowchart of a method implemented at a terminal device according to some embodiments of the present disclosure;

FIG. 6 illustrates a flowchart of a method implemented at a network device according to some embodiments of the present disclosure;

FIG. 7 illustrates a simplified block diagram of a device that is suitable for implementing some example embodiments of the present disclosure; and

FIG. 8 illustrates a block diagram of an example of a computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As stated above, in NR, the SCell is configured to be in an activated or deactivated state. The SCell may be configured to be in the deactivated state to enable reasonable UE battery consumption when CA is configured. In the deactivated state, the UE activity is low for example related to the monitoring of physical downlink (DL) control channel (PDCCH) measurements. While in the activated state, the UE activity is frequent. To transit from the deactivated state to the activated state the network needs to activate the deactivated SCell. Upon reception of an SCell activation command, it takes time for the UE to change from the deactivated state to the activated state. This delay is known as the SCell activation delay i.e. activation delay to transit from the deactivated state to the activated state.

The SCell activation delay requirement was originally defined in LTE and used as a baseline for defining the initial NR SCell activation delay requirement. The requirement has been optimized since Release 15. The SCell activation delay requirement, T_{activation_time}, for activating a DL-only SCell is specified in Technical Specification (TS) 38.133. The maximum delay is specified within which the UE shall complete the SCell activation after which the UE is able to perform data reception in the activated SCell. By the end of SCell activation, the UE shall be able to transmit the valid channel state information (CSI) reporting for the SCell being activated.

For the FR2 unknown SCell, the activation delay is defined as below:

If the Primary Cell (PCell)/Primary SCell (PSCell) and the target SCell are configured as FR1-FR2 CA or if the PCell/PSCell and the target SCell are in an FR2 band pair with independent beam management, and the target SCell is unknown to the UE and the semi-persistent CSI reference signal (CSI-RS) is used for CSI reporting, provided that the side condition Ês/Iot≥−2 dB is fulfilled, then the T_{activation_time} is:

$$6 ms + {T}_{FirstSSB \_ MAX} + 15 * {T}_{SMTC \_ MAX} + 8 * {T}_{rs} + {T}_{L 1 - RSRP , measure} + {T}_{L 1 - RSRP , report} + {T}_{HARQ} + max ( {T}_{uncertainty \_ MAC} + {T}_{FineTiming} + 2 ms , {T}_{uncertainty \_ SP} ) .$$

If the PCell/PSCell and the target SCell are configured as FR1-FR2 CA or if the PCell/PSCell and the target SCell are in an FR2 band pair with independent beam management, and the target SCell is unknown to the UE and the periodic CSI-RS is used for CSI reporting, provided that the side condition Ês/Iot≥−2 dB is fulfilled, then the T_{activation_time} is:

$$3 ms + {T}_{FirstSSB \_ MAX} + 15 * {T}_{SMTC \_ MAX} + 8 * {T}_{rs} + {T}_{L 1 - RSRP , measure} + {T}_{L 1 - RSRP , report} + max \{ ( {T}_{HARQ} + {T}_{uncertainty \_ MAC} + 5 ms + {T}_{FineTiming} ) , ( {T}_{uncertainty \_ RRC} + {T}_{RRC \_ delay} ) \} .$$

As shown above, the UE needs to acquire the beam information via L1-RSRP measurement in order to activate the FR2 unknown SCell. Similarly, L1-RSRP measurement is also needed in the FR1 if the SCell is unknown and non-contiguous to an active cell in the same band.
otherwise, provided that the side condition Ês/Iot≥−2 dB is fulfilled, T_{activation_time} is:
   6 ms+T_{FirstSSB_MAX}+T_{SMTC_MAX}+Tᵣₛ+T_{L1-RSRP,measure}+T_{L1-RSRP,report}+T_{HARQ}+max(T_{uncertainty_MAC}+T_{FineTiming}+2 ms, T_{uncertainty_SP}), if the semi-persistent CSI-RS is used for CSI reporting,
   3 ms+T_{FirstSSB_MAX}+T_{SMTC_MAX}+Tᵣₛ+T_{L1-RSRP,measure}+T_{L1-RSRP,report}+max(T_{HARQ}+T_{uncertainty_MAC}+5 ms+T_{FineTiming}, T_{uncertainty_RRC}+T_{RRC_delay}), if the periodic CSI-RS is used for CSI reporting.
where the above-mentioned parameters have the following meanings.

In the FR1, in the case of intra-band SCell activation, T_{SMTC_MAX} represents the longer SMTC periodicity between active serving cells and SCell being activated provided the cell-specific reference signals from the active serving cells and the SCells being activated or released are available in the same slot; in case of inter-band SCell activation, T_{SMTC_MAX} represents the SMTC periodicity of SCell being activated; in the FR2, T_{SMTC_MAX} represents the longer SMTC periodicity between active serving cells and SCell being activated provided that in Rel-15 only support FR2 intra-band CA. T_{SMTC_MAX} can be bounded to a minimum value of 10 ms.

Tᵣₛ represents the SMTC periodicity of the SCell being activated if the UE has been provided with an SMTC configuration for the SCell in the SCell addition message, otherwise, Tᵣₛ represents the SMTC configured in the measObjectNR having the same synchronization signal block (SSB) frequency and subcarrier spacing; if the UE is not provided SMTC configuration or measurement object on this frequency, the requirement which involves Tᵣₛ is applied with Tᵣₛ=5 ms assuming the SSB transmission periodicity is 5 ms; there are no requirements if the SSB transmission periodicity is not 5 ms.

T_{FirstSSB_MAX} represents the time to the end of the first complete SSB burst indicated by the SMTC after slot

$$n + \frac{{T}_{HARQ} + 3 ms}{NR slot length} ,$$

further fulfilling:

In the FR1, in the case of intra-band SCell activation, the occasion when all active serving cells and SCells being activated or released are transmitting SSB bursts in the same slot; in the case of inter-band SCell activation, the first occasion when the SCell being activated is transmitting SSB burst.

In the FR2, the occasion when all active serving cells and SCells being activated or released are transmitting SSB bursts in the same slot.

T_{FineTiming} represents the time period between UE finishes processing the last activation command for PDCCH transmission configuration indicator (TCI), physical downlink shared channel (PDSCH) TCI (when applicable) and the timing of first complete available SSB corresponding to the TCI state.

T_{L1-RSRP, measure} represents L1-Reference Signal Received Power (L1-RSRP) measurement delay T_{L1-RSRP_Measurement_Period_SSB} ms or T_{L1-RSRP_Measurement_Period_CSI-RS} based on applicability as defined in clause 9.5 assuming M=1.

T_{L1-RSRP, report} represents the delay of acquiring CSI reporting resources.

T_{uncertainty_MAC} represents the time period between reception of the last activation command for PDCCH TCI, PDSCH TCI (when applicable) relative to SCell activation command for known case; First valid L1-RSRP reporting for the unknown case.

T_{uncertainty_RRC} represents the time period between reception of the RRC configuration message for TCI of periodic CSI-RS for CQI reporting (when applicable) relative to SCell activation command for known case; First valid L1-RSRP reporting for the unknown case.

T_{uncertainty_SP} represents the time period between reception of the activation command for semi-persistent CSI-RS resource set for CQI reporting relative to SCell activation command for known case; First valid L1-RSRP reporting for the unknown case.

T_{RRC_delay} represents the RRC procedure delay.

In these cases, the L1-RSRP measurement delay is defined as shown in Table 1 (see TS 38133 clause 9.5.4.1), where N=8 UE receive (Rx) beams are assumed for the L1-RSRP measurement. This considers the worse case where the UE has no information about the SCell and hence needs to measure on all the beams to ensure the activation.

TABLE 1
Measurement period TL1-RSRP Measurement
Period SSB for the FR2

| Configuration | T_{L1-RSRP}_{_{—}}_{Measurement}_{_{—}}_{Period}_{_{—}}_{SSB} (ms) |
|---|---|
| non-discontinuous | max(T_{Report}, ceil(M*P*N)*T_{SSB}) |
| reception (DRX) | |
| DRX cycle ≤ 320 ms | max(T_{Report}, ceil(1.5*M*P*N)*max(T_{DRX}, T_{SSB})) |
| DRX cycle > 320 ms | ceil(1.5*M*P*N)*TDRX |

Note:
TSSB = ssb-periodicityServingCell is the periodicity of the SSB-Index configured for L1-RSRP measurement. T_{DRX} is the DRX cycle length. T_{Report} is configured periodicity for reporting.

In Release 18, it is approved in RAN #95e to reduce the SCell activation delay in the FR2, although any solution may not be limited to the FR2.

For the SCell activation procedure, the above activation delay requirement is based on the SCell conditions at the reception of the activation command and during the activation time, including if the SCell is known or unknown, if the SCell belongs to the FR1 or the FR2, if there is already a serving cell on the same FR2 band or not, if periodic or semi-persistent channel state information-reference signal (SP-CSI-RS) is used for CSI reporting, etc.

In particular, if the SCell to be activated is unknown in the FR2, the UE needs to perform cell detection, time/frequency tracking, and L1-RSRP measurements to acquire the beam information and report the beam information e.g. L1-RSRP to the network via the L1-RSRP report. The network can then use the received L1-RSRP to determine which DL beam (also referred to as transmit beam) is best from the UE point of view and configure the TCI information to the UE which will indicate the specific DL beam(s) the UE needs to monitor.

Thus, on one hand, there are multiple transmit (Tx) beams from the BS which are identified by respective reference signals, for example, Synchronization Signal Blocks (SSBs) and/or CSI-RSs. The UE needs to detect the DL beam RS and needs to perform a sweep to detect the Tx beams. This is done during a normal Radio Resource Management (RRM) measurement procedure including during the cell detection and measurements and the UE results including the beam information are then reported to the network.

It is assumed that for the FR2, the UE uses different spatial Rx settings for Layer 3 (L3) measurements and L1 measurements, and therefore these measurements may not be assumed possible to be performed simultaneously by the UE but would be assumed performed in a serial manner. The current assumption is that the network would need L1-RSRP measurements from the UE for beam management (BM). Based on the L1-RSRP report, the network will determine which DL Tx beam is most suitable for scheduling the UE and send a TCI indication to the UE. Hence which DL RS to use for DL reception and thereby which DL beams to be used by the UE is explicitly indicated by the network via the TCI indication.

On the other hand, the UE may also maintain a plurality of Rx beams. That is, in addition to the Tx beams from the network, the UE needs to sweep its own Rx beams in order to determine the best Rx beam settings for data transmission. But the Rx beams handling/selection is up to UE implementation. In the context of FR2 unknown SCell activation, it has bee assumed the cell detection and measurements are performed using wide/rough (non-refined) Rx spatial (Rx beam) settings at the UE, and the L1-RSRP measurements are based on narrow/refined Rx spatial (Rx beam) settings at the UE. Thus, an additional L1-RSRP measurement delay is needed following the cell detection delay, for the reason that there is a need to allow the UE to select the best-refined beam for the following CSI measurements and data transmission.

While the best-refined beam indeed provides more accurate channel state information to the network and better channel quality for the UE, it is at the cost of additional delay in the activation before the UE can be scheduled. It adds delays related to L1-RSRP measurement delay, for example, 8*T_{SSB}, CSI-RS configuration and activation, and CSI measurement delay for estimating the exact channel quality and reporting. This further delays the readiness of the SCell and when the UE is ready for data transmission. It is noted the data transmission is not in practice possible on the target SCell until the end of SCell activation ending with the CSI report indicating non-Out of Range, that is, until the valid CSI reporting.

Therefore, the longer the activation delay is, the more channel capacity is wasted, which reduces the throughput. Optimizing the SCell activation procedure to further improve transmission efficiency is still an important issue to be solved.

According to embodiments of the present disclosure, there is providing a scheme for data transmission at SCell activation. With this scheme, a terminal device determines that a first data transmission (also referred to as an early data transmission) in a SCell provided by a network device is possible during an activation procedure of the SCell. Then, the terminal device transmits, to the network device, a first beam report (also referred to as an early beam report) of one or more transmit beams for the SCell. Moreover, the terminal device receives, from the network device, scheduling of the first data transmission in the SCell.

This scheme optimizes SCell activation by enabling early data transmission during the SCell activation procedure. In this way, the SCell activation is optimized by reducing the time between UE receiving the activation command and enabling data transmission as early as possible during the SCell activation procedure. As such, it is possible to improve communication efficiency.

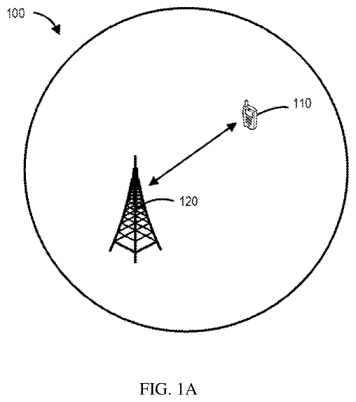

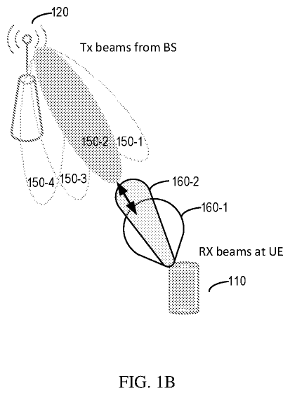

Principle and embodiments of the present disclosure will be described in detail below with reference to the accompanying drawings. Reference is first made to FIG. 1A, which illustrates an example environment 100 in which example embodiments of the present disclosure can be implemented.

The environment 100, which may be a part of a communication network, comprises a terminal device 110 and a network device 120 communicating with each other or with other devices via each other.

The communication environment 100 may comprise any suitable number of devices and cells. In the communication environment 100, the terminal device 110 and the network device 120 can communicate data and control information with each other. A link from the network device 120 to the terminal device 110 is referred to as a DL, while a link from the terminal device 110 to the network device 120 is referred to as an uplink (UL). The terminal device 110 can be configured with more than one cell. In some example embodiments, the terminal device 110 can be connected to a PCell and an SCell under the control of the network device 120.

It is to be understood that two devices are shown in the environment 100 only for the purpose of illustration, without suggesting any limitation to the scope of the present disclosure. In some example embodiments, the environment 100 may comprise a further device to communicate with the terminal device 110 and network device 120.

The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connectivity (DC), and New Radio Unlicensed (NR-U) technologies.

Reference is now made to FIG. 1B, which shows a schematic diagram of beamforming at the network device and terminal device sides according to some embodiments of the present disclosure. For the purpose of discussion, FIG. 1B will be described with reference to FIG. 1A.

As shown in FIG. 1B, there are multiple Tx beams 150-1 to 150-4 from the network device 120. The terminal device 110 performs a beam sweep to detect the multiple Tx beams 150-1 to 150-4. The terminal device 110 has a non-refined beam 160-1 and a refined beam 160-2.

In some example embodiments, if an SCell to be activated is unknown in the FR2, the terminal device 110 may need to perform cell detection, time/frequency tracking, and L1-RSRP measurements to acquire the beam information and report L1-RSRP to the network device 120 via the L1-RSRP report. In this case, during the cell detection, the terminal device 110 may use the non-refined beam 160-1 to detect the multiple Tx beams 150-1 to 150-4. Then, during the L1-RSRP measurement, the terminal device 110 may use the refined beam 160-2 to detect the multiple Tx beams 150-1 to 150-4, and the results of the beam measurements are then reported to the network device 120. The network device 120 may then use the received L1-RSRP to determine which DL beam is best from the terminal device 110's point of view and configure the TCI information to the terminal device 110 which will indicate the specific DL beam(s) the terminal device 110 needs to monitor.

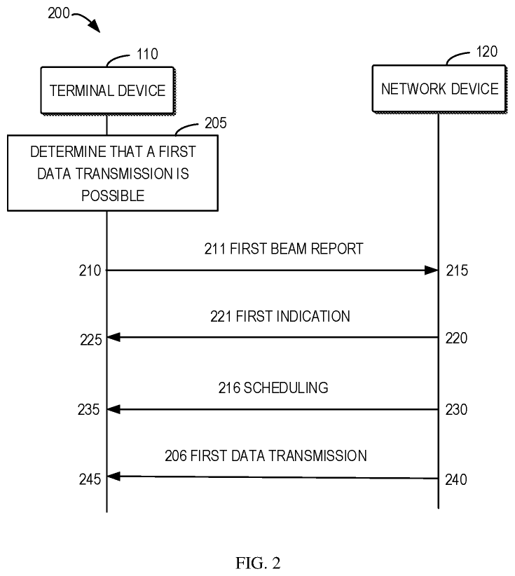

FIG. 2 illustrates a signaling flow 200 between the terminal device and the network device according to some example embodiments of the present disclosure. For the purpose of discussion, the signaling flow 200 will be described with reference to FIG. 1A.

As shown in FIG. 2, the terminal device 110 determines (205) that a first data transmission 206 in a SCell provided by the network device 120 is possible during an activation procedure of the SCell. The terminal device 110 transmits (210), to the network device 120, a first beam report 211 of one or more transmit beams for the SCell. The first beam report 211 of one or more transmit beams for the SCell may also be transmitted in other SCell configured with PUCCH e.g. in a PUCCH SCell with a valid timing advance. On the other side of the transmission, the network device 120 receives (215) the first beam report 211. For example, the first beam report 211 may comprise one or more reference signal received power (RSRP) of the reference signals on the one or more transmit beams of the network device 120. Then, the network device 120 may determine at least one transmit beam for the SCell used for scheduling 216 of the first data transmission 206 in the SCell based on the first beam report 211. The network device 120 transmits (220), to the terminal device 110, a first indication 221 of the at least one transmit beam for the SCell. Accordingly, the terminal device 110 receives (225) the first indication 221. Moreover, the network device 120 transmits (230), to the terminal device 110, the scheduling 216 of the first data transmission 206 using the least one transmit beam. On the receiving side, the terminal device 110 receives (235) the scheduling 216 of the first data transmission 206. Further, the network device 120 transmits (240), to the terminal device 110 in the SCell, the first data transmission 206 based on the scheduling 216 of the first data transmission 206 during the activation procedure of the SCell, for example, using the least one transmit beam. At the terminal device 110, it receives the first data transmission 206 based on the first indication 221.

In some example embodiments, the terminal device 110 may perform a cell detection in the activation procedure of the SCell. As an example, the cell detection may be performed based on a non-refined beam of the terminal device 110. Then, for example, the terminal device 110 may transmit the first beam report 211 after completing the cell detection. In this case, the first beam report 211 may be based on a measurement during the cell detection, and thus, the first beam report 211 may be obtained based on the non-refined receive beam. For example, the first beam report may be based on the one-shot measurement sample of SSBs during the cell detection. Alternatively or in addition, the first beam report 211 may be based on a measurement performed by the terminal device 110 in a deactivated state of the SCell, and the terminal device 110 may transmit the first beam report 211 after receiving the SCell activation command. As an example, in this case, the first beam report may be based on a beam-level (SSB Index) L3 measurement performed on the SCell. Although the above measurement is not based on possible refined Rx beam settings but based on the non-refined Rx beam settings, this measurement information may indicate the DL range of candidate transmit beams that may be used for scheduling the terminal device 110 and which the terminal device 110 may need to monitor.

For example, the terminal device 110 may transmit the first beam report 211 if it determines the SCell is unknown. As another example, the terminal device 110 may transmit the first beam report 211 if it determines that a CSI-RS is not configured for the measurement for the second beam report e.g. the L1-RSRP measurement. In this case, there is no need for the terminal device 110 to perform L1-RSRP measurements based on the refined beam. As another example, the terminal device 110 may transmit the first beam report 211 if it determines that an antenna gain difference between a non-defined beam and a refined beam of the terminal device 100 is within a margin threshold. That is, if an antenna gain difference between the L1-RSRP measurement and the L3 measurement is within a threshold, the terminal device 110 may transmit the first beam report 211. Alternatively or in addition, the terminal device 110 may transmit the first beam report 211 if it determines that at least one measurement result of the one or more transmit beams is higher than a threshold, which means that the channel condition is assumed good enough. As a further example, the terminal device 110 may transmit the first beam report 211 in response to an activation command for the secondary cell, if it has a valid radio resource management measurement result on the secondary cell, transmitting the first beam report.

In some example embodiments, the terminal device 110 may transmit the first beam report 211 on a physical uplink control channel (PUCCH) or a physical uplink shared channel (PUSCH) configured for beam reporting. For example, the first beam report 211 may be transmitted on the available PUCCH/PUSCH resources for L1-RSRP reporting. As the first beam report 211 may reuse available resources for L1-RSRP reporting, no additional resource is needed for the transmission of the first beam report 211. Thus, there is no need to introduce any signaling overhead. Alternatively or in addition, the terminal device 110 may transmit, to the network device 120, a request for allocating a resource for transmitting the first beam report 211. Then, the network device 120 may allocate the resource for the terminal device 110 and transmit, to the terminal device 110, an indication of the allocated resource. The terminal device 110 may then transmit the first beam report 211 on the allocated resource. Accordingly, the network device 120 may receive the first beam report 211 on the allocated resource. In this case, the first beam report 211 may be transmitted as a measurement report different from the available L1-RSRP measurement report.

In some example embodiments, the terminal device 110 may only report the best transmit beam, that includes the best DL RS, of the network device 120, and this DL RS is then being selected as representing the implicitly activated DL beam. In this case, the terminal device 110 may be directly scheduled on this DL RS based on the first beam report without transmitting the first indication 221.

In some example embodiments, the terminal device 110 may report a plurality of transmit beams. In this case, the network device 120 may determine, from the plurality of transmit beams, the at least one transmit beam for the SCell used for the scheduling 216 of the first data transmission 206. Then, the network device 120 may transmit the first indication 221 to inform (or confirm) the transmit beam(s) the terminal device 110 is supposed to monitor for the scheduling 216. The first indication 221 may be also referred to as an early DL beam activation or indication command, such as a TCI activation-alike command.

In some example embodiments, based on receiving the first indication 221 of the at least one transmit beam for the SCell, the terminal device 110 may monitor the at least one transmit beam indicated by the first indication 221 for the scheduling 216 of the first data transmission 206. Then, for example, after receiving the scheduling 216, the terminal device 110 may receive, from the network device 120, the first data transmission 206 using the non-refined receive beam based on the received scheduling 216.

In some example embodiments, the network device 120 may avoid the scheduling 216 of the first data transmission 206 on a resource that is overlapping with a reference signal on which a measurement based on a refined beam, for example, traditional L1-RSRP measurement, is to be performed. In this case, during the SCell activation, the terminal device 110 is not expected to be scheduled on the orthogonal frequency division multiplexing (OFDM) symbols overlapping with SSB and/or CSI-RS resources configured for the L1-RSRP measurement. That is, the scheduling restriction may apply to ensure the L1-RSRP measurement based on the refined beam.

In some example embodiments, the terminal device 110 may perform the measurement based on a refined beam, for example, the traditional L1-RSRP measurement, in parallel with the first data transmission 206. That is, in this case, in parallel, the terminal device 110 may continue the traditional L1-RSRP measurement to further obtain refined beam information. Then, the terminal device 110 may obtain a second beam report of one or more transmit beams for the SCell based on the refined beams. The terminal device 110 may then transmit the second beam report to the network device 120. For example, the terminal device 110 may transmit the second beam report if it determines that the second beam report is different from the first beam report 211. As another example, the terminal device 110 may transmit the second beam report if it determines that a difference between the first beam report 211 and the second beam report is greater than a difference threshold. Alternatively or in addition, the terminal device 110 may transmit the second beam report if it determines that different transmit beams are to be determined based on the first beam report 211 and the second beam report.

Based on the second beam report, the network device 120 may determine at least one transmit beam for the SCell used for scheduling of a second data transmission in the SCell. Then, the network device 120 may transmit a second indication for the determined at least one transmit beam to the terminal device 110.

In some example embodiments, based on receiving the second indication of the at least one transmit beam for the SCell, the terminal device 110 may monitor the at least one transmit beam indicated by the second indication for the scheduling of the second data transmission. Then, for example, after receiving the scheduling of the second data transmission, the terminal device 110 may receive, from the network device 120, the second data transmission using the refined receive beam based on the received scheduling of the second data transmission.

In some example embodiments, the network device 120 may transmit a reference signal used for a channel measurement using the at least one transmit beam determined based on the first beam report 211. Accordingly, the terminal device 110 may receive the reference signal used for the channel measurement based on the at least one transmit beam indicated by the first indication 221. In this case, the terminal device 110 may perform the channel measurement in parallel with the measurement for the second beam report. In this way, the second data transmission can be further advanced and thus the activation delay can be further reduced.

With the proposed early beam report, the terminal device 110 can be able to inform the network device 120 of the transmit beam information of the network device 120 at the earliest time though based on the rough UE Rx beam settings. The network device 120 can thus be able to schedule the terminal device 110 while the terminal device 110 potentially continues refining the Rx beam settings via continued L1-RSRP measurements. In this way, the early data transmission is allowed on the proper transmit beam before the refined beam is fully determined. Hence, not always using the refined UE beam settings and preventing the UE from being scheduled using the wide beam available at the UE can help reduce the time before SCell can be scheduled. This minimizes the negative impact due to SCell activation delay. Allowing the first data transmission within the activation delay can help improve the SCell usage.

It should be understood that the proposed scheme can work with the existing requirements as an additional activation enhancement step.

For example, the SCell activation delay may be reformulated as below:

If the SCell being activated belongs to the FR2 and if there is no active serving cell on that FR2 band provided that PCell or PSCell is in the FR1 or in the FR2:

If the target SCell is known to the UE and the semi-persistent CSI-RS is used for CSI reporting, then the T_{activation_time} is:
3 ms+max(T_{uncertainty_MAC}+T_{FineTiming}+2 ms, T_{uncertainty_SP}), where T_{uncertainty_MAC}=0 and T_{uncertainty_SP}=0 if the UE receives the SCell activation command, semi-persistent CSI-RS activation command, and TCI state activation command at the same time.

If the target SCell is known to the UE and the periodic CSI-RS is used for CSI reporting, then the T_{activation_time} is:
max(T_{uncertainty_MAC}+5 ms+T_{FineTiming}, T_{uncertainty_RRC}+T_{RRC_delay}-T_{HARQ}), where T_{uncertainty_MAC}=0 if the UE receives the SCell activation command and TCI state activation commands at the same time.

If the PCell/PSCell and the target SCell are configured as FR1-FR2 CA or if the PCell/PSCell and the target SCell are in an FR2 band pair with independent beam management, and the target SCell is unknown to the UE and the semi-persistent CSI-RS is used for CSI reporting, provided that the side condition Ês/Iot≥−2 dB is fulfilled, then the T_{activation_time} is:
6 ms+T_{FirstSSB_MAX}+15*T_{SMTC_MAX}+8*Tᵣₛ+T_{HARQ}+max (T_{L1-RSRP, measure}+T_{L1-RSRP, report}, T_{L1-RSRP, report}+max(T_{uncertainty_MAC}+T_{FineTiming}+2 ms, T_{uncertainty_SP})), if an early L1-RSRP report is sent after cell detection; or

$$3 ms + {T}_{FirstSSB \_ MAX} + 15 * {T}_{SMTC \_ MAX} + 8 * {T}_{rs} + {T}_{L 1 - RSRP , measure} + {T}_{L 1 - RSRP , report} + max \{ ( {T}_{HARQ} + {T}_{uncertainty \_ MAC} + 5 ms + {T}_{FineTiming} ) , ( {T}_{uncertainty \_ RRC} + {T}_{RRC \_ delay} ) \} .$$

If the PCell/PSCell and the target SCell are configured as FR1-FR2 CA or if the PCell/PSCell and the target SCell are in an FR2 band pair with independent beam management, and the target SCell is unknown to the UE and the periodic CSI-RS is used for CSI reporting, provided that the side condition Ês/Iot≥−2 dB is fulfilled, then the T_{activation_time} is:
3 ms+T_{FirstSSB_MAX}+15*T_{SMTC_MAX}+8*Tᵣₛ+T_{HARQ}+max (T_{L1-RSRP, measure}+T_{L1-RSRP, report}, T_{L1-RSRP, report}+T_{uncertainty_MAC}+5 ms+T_{FineTiming}, T_{uncertainty_RRC}+T_{RRC_delay}), if an early L1-RSRP report is sent, or

$$6 ms + {T}_{FirstSSB \_ MAX} + 15 * {T}_{SMTC \_ MAX} + 8 * {T}_{rs} + {T}_{L 1 - RSRP , measure} + {T}_{L 1 - RSRP , report} + {T}_{HARQ} + max ( {T}_{uncertainty \_ MAC} + {T}_{FineTiming} + 2 ms , {T}_{uncertainty \_ SP} ) , otherwise ;$$

For example, starting from the slot specified in clause 4.3 of TS 38.213 [3] (timing for SCell activation/deactivation) and until the terminal device 110 has completed a first L1-RSRP measurement, the terminal device 110 shall report the lowest valid L1 synchronization signal-RSRP (SS-RSRP) range if the terminal device 110 has available uplink resources to report L1-RSRP for the SCell except an early L1-RSRP report is sent.

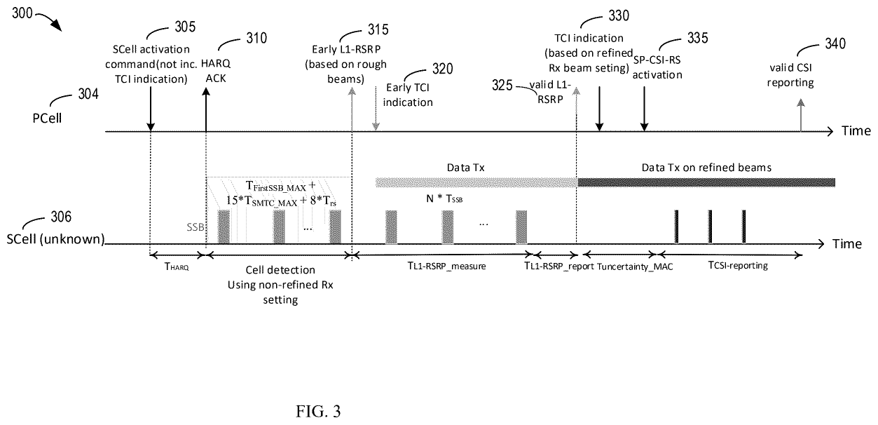

FIG. 3 illustrates an example process 300 of enabling early data transmission at SCell activation according to some embodiments of the present disclosure. For the purpose of discussion, the process 300 will be described with reference to FIG. 1A. It would be appreciated that although the process 300 has been described in the network environment 100 of FIG. 1A, this process flow may be likewise applied to other communication scenarios.

At 305, the network device 120 transmits, to the terminal device 110, an SCell activation command to activate a target SCell 306 provided by the network device 120. For example, the terminal device 110 determines the SCell 306 as unknown in the FR2. At 310, the terminal device 110 transmits, to the network device 120, a HARQ ACK reply. Then, the terminal device 110 starts performing cell detection and time/frequency tracking. For example, the cell detection may comprise beam sweeping based on a non-refined beam.

Then, at 315, the terminal device 110 transmits, to the network device 120, an early L1-RSRP report immediately after the cell detection. For example, the terminal device 110 may transmit the early L1-RSRP report if it determines that the antenna margin, also referred to as a antenna gain difference, between the rough and refined beams is within a threshold. Alternatively, the terminal device 110 may transmit the terminal device 110 transmit if it is not having the intention to refine the Rx setting further in its implementation.

For example, the terminal device 110 may select the best one or more DL beams from the network device 120 and transmits an early L1-RSRP report corresponding to the selected beams, for example, based on SSB indexes. As an example, the early L1-RSRP report may include the SSB Index and result from the best DL beam based on a one-shot measurement result of the latest SSBs. As another example, the terminal device 110 may transmit to the network device 120, a list of early L1-RSRP reports corresponding to all detected and measured SSBs, for example, including the SSB Indexes. Based on the reported results, the network device 120 may select at least one DL beam for the terminal device 110 to monitor for possible scheduling. Then, at 320, the network device 120 indicates to the terminal device 110 for example using an early DL beam activation command (such as a TCI activation command) which DL beam the terminal device 110 is to monitor for possible scheduling.

Then, the terminal device 110 starts monitoring the indicated DL beam for possible scheduling on the rough DL beam indicated in the DL beam activation command after receiving the early DL beam activation command. Meanwhile, the terminal device 110 keeps performing L1-RSRP measurements on SSB and/or CSI-RSs potentially using refined Rx beams setting. For example, the terminal device 110 is not expected to be scheduled on the symbols where L1-RSRP measurement would happen.

At 325, the terminal device 110 sends a valid L1-RSRP report which is obtained based on refined beams informing the refined beam information to the network device 120, and reports accordingly. For example, the valid L1-RSRP may be reported only if it is different from the early L1-RSRP report, or may result in different DL beams for the terminal device 110 to monitor. At 330, the network device 120 updates the TCI state based on the received valid L1-RSRP report if needed as in the legacy SCell activation procedure.

After a new DL beam is determined based on the valid L1-RSRP measurement, at 335, the network device 120 sends SP-CSI-RS activation command or configures periodic CSI-RS resources for measurements if in use. Then, at 340, the terminal device 110 responds with valid CSI reporting as the end of the activation procedure.

All operations and features as described above with reference to FIG. 2 are likewise applicable to the process 300 and have similar effects. For the purpose of simplification, the details will be omitted.

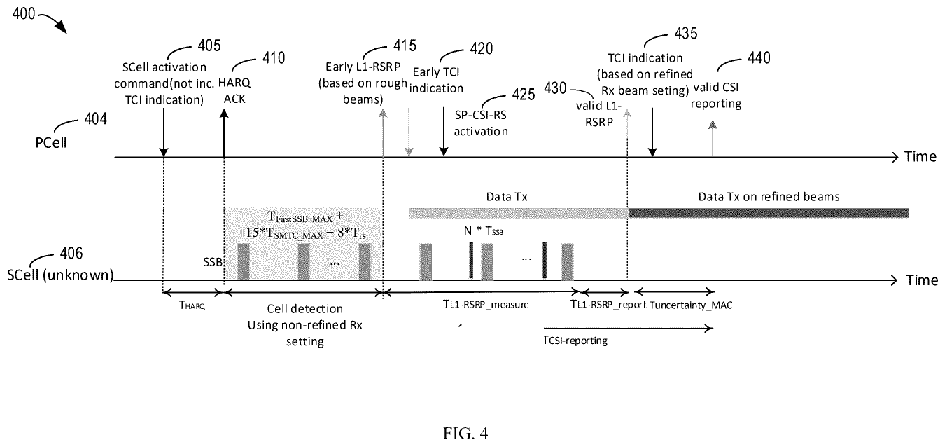

FIG. 4 illustrates another example process 400 of enabling early data transmission at SCell activation according to some other embodiments of the present disclosure. For the purpose of discussion, the process 400 will be described with reference to FIG. 1A. It would be appreciated that although the process 400 has been described in the network environment 100 of FIG. 1A, this process flow may be likewise applied to other communication scenarios.

As shown in FIG. 4, at 405, the network device 120 transmits, to the terminal device 110, an SCell activation command to activate the target SCell 406. At 410, the terminal device 110 transmits, to the network device 120, a HARQ ACK reply. At 415, the terminal device 110 starts performing cell detection and time/frequency tracking based on a non-refined beam. At 420, the terminal device 110 transmits, to the network device 120, an early L1-RSRP report immediately after the cell detection.

Then, at 425, the SP-CSI-RS or persistent CSI-RS (P-CSI-RS) is activated or configured based on the early L1-RSRP report or early TCI indication. In this case, SP-CSI-RS resources are activated on the DL beam(s) indicated by early TCI indication. Thus, the terminal device 110 is able to perform channel measurements in parallel with L1-RSRP measurements. This may further reduce the SCell activation delay.

Then, at 430, the terminal device 110 sends a valid L1-RSRP report which is obtained based on refined beams informing the refined beam information to the network device 120. At 435, the network device 120 may update the TCI state based on the received valid L1-RSRP report as in the legacy SCell activation procedure. Then, at 440, the terminal device 110 responds with valid CSI reporting as the end of the activation procedure.

All operations and features as described above with reference to FIG. 2 are likewise applicable to the process 400 and have similar effects. For the purpose of simplification, the details will be omitted.

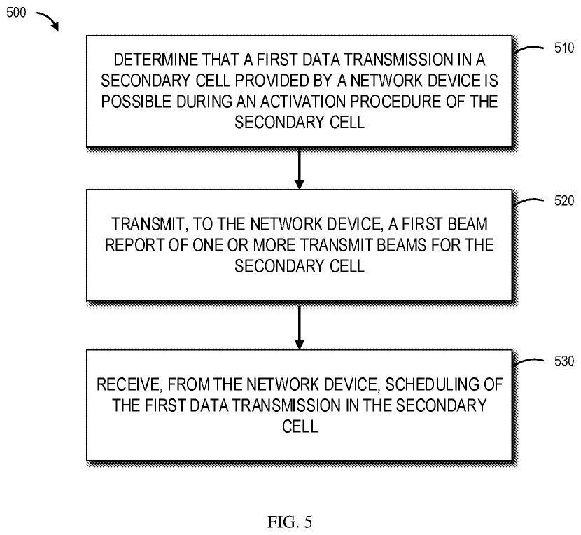

FIG. 5 illustrates a flowchart 500 of a method implemented at a terminal device 110 according to some embodiments of the present disclosure. For the purpose of discussion, the method 500 will be described from the perspective of the terminal device 110 with reference to FIG. 1A.

At block 510, the terminal device 110 determines that a first data transmission in a secondary cell provided by a network device 120 is possible during an activation procedure of the secondary cell. At block 520, the terminal device 110 transmits, to the network device 120 provided by the network device 120, a first beam report of one or more transmit beams for the secondary cell. At block 530, the terminal device 110 receives, from the network device 120, scheduling of the first data transmission in the secondary cell. The scheduling of the first data transmission may be transmitted in SCell.

In some example embodiments, the terminal device 110 performs a cell detection in the activation procedure of the secondary cell, and the terminal device 110, in accordance with completing the cell detection, transmits the first beam report.

In some example embodiments, the terminal device 110 receives, from the network device 120, a first indication of at least one transmit beam for the secondary cell, the at least one transmit beam being based on the first beam report and used for the scheduling of the first data transmission in the secondary cell; and receives, from the network device 120 in the secondary cell, the first data transmission based on the first indication during the activation procedure.

In some example embodiments, the terminal device 110 monitors the least one transmit beam indicated by the first indication for the scheduling of the first data transmission.

In some example embodiments, the terminal device 110 receives the first data transmission using a non-refined receive beam of the terminal device 110.

In some example embodiments, the first beam report is obtained based on a non-refined receive beam of the terminal device 110.

In some example embodiments, the terminal device 110 performs, a measurement based on a refined beam of the terminal device 110 in parallel with the first data transmission; transmits, to the network device 120, a second beam report of one or more transmit beams for the secondary cell, the second beam report being obtained based on the measurement; and receives, from the network device 120, a second indication of at least one transmit beam for the secondary cell, the at least one transmit beam indicated by the second indication being based on the second beam report and used for scheduling of a second data transmission in the secondary cell.

In some example embodiments, the terminal device 110 receives a reference signal used for a channel measurement based on the at least one transmit beam indicated by the first indication; and performs the channel measurement in parallel with the measurement for the second beam report.

In some example embodiments, the terminal device 110, in accordance with a determination that the second beam report is different from the first beam report, or a difference between the first beam report and the second beam report is greater than a difference threshold, transmits the second beam report.

In some example embodiments, the terminal device 110, in accordance with a determination that different transmit beams are to be determined based on the first beam report and the second beam report, transmits the second beam report.

In some example embodiments, the terminal device 110, in accordance with a determination that a channel state information reference signal is not configured for the measurement for the second beam report, transmits the first beam report.

In some example embodiments, the first data transmission is not scheduled on a resource that is overlapping with a reference signal on which the measurement for the second beam report is to be performed.

In some example embodiments, the terminal device 110, in accordance with a determination that a gain difference between a non-defined beam and a refined beam of the terminal device 110 is within a margin threshold, transmits the first beam report.

In some example embodiments, the terminal device 110, in accordance with a determination that at least one measurement result of the one or more transmit beams is higher than a threshold, transmits the first beam report.

In some example embodiments, the terminal device 110, in accordance with having a valid radio resource management measurement result on the secondary cell, transmits the first beam report in response to an activation command for the secondary cell.

In some example embodiments, the first beam report comprises one or more reference signal received power of the one or more transmit beams.

In some example embodiments, the first beam report is based on a measurement performed by the terminal device 110 during the cell detection.

In some example embodiments, the first beam report is based on a measurement performed by the terminal device 110 in a deactivated state of the secondary cell.

In some example embodiments, the first beam report is transmitted on a physical uplink control channel or a physical uplink shared channel configured for beam reporting.

In some example embodiments, the terminal device 110 transmits, to the network device 120, a request for allocating a resource for transmitting the first beam report; and receives, from the network device 120, an indication of the resource allocated by the network device 120. Moreover, the terminal device 110 transmits the first beam report on the resource allocated by the network device 120.

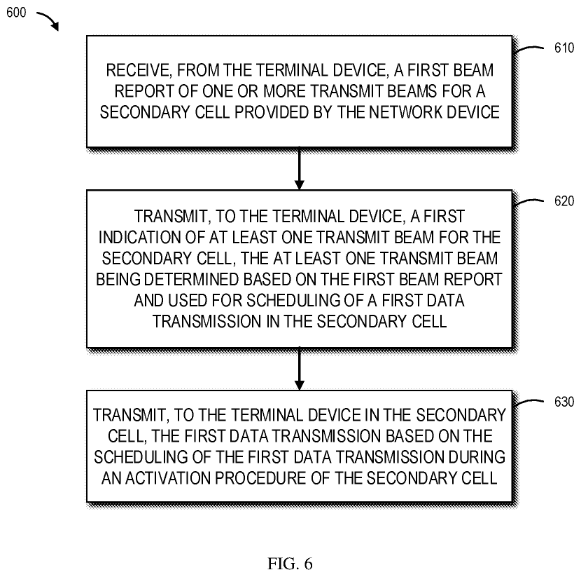

FIG. 6 illustrates a flowchart 600 of a method implemented at a network device 120 according to some embodiments of the present disclosure. For the purpose of discussion, the method 600 will be described from the perspective of the network device 120 with reference to FIG. 1A.

At block 610, the network device 120 receives, from the terminal device 110 120, a first beam report of one or more transmit beams for a secondary cell provided by the network device 120. At block 620, the network device 120 transmits, to the terminal device 110, a first indication of at least one transmit beam for the secondary cell, the at least one transmit beam being determined based on the first beam report and used for scheduling of a first data transmission in the secondary cell. At block 630, the network device 120 transmits, to the terminal device 110 in the secondary cell, the first data transmission based on the scheduling of the first data transmission during an activation procedure of the secondary cell.

In some example embodiments, the network device 120 transmits, to the terminal device 110, the scheduling of the first data transmission using the least one transmit beam.

In some example embodiments, the network device 120 transmits the first data transmission using the at least one transmit beam.

In some example embodiments, the network device 120 transmits a reference signal used for a channel measurement using the at least one transmit beam.

In some example embodiments, the first beam report comprises one or more reference signal received power of the one or more transmit beams.

In some example embodiments, the first beam report is received on a physical uplink control channel or a physical uplink shared channel configured for beam reporting.

In some example embodiments, the network device 120 receives, from the terminal, a request for allocating a resource for transmitting the first beam report, and transmits, to the terminal device 110, an indication of a resource allocated by the network device 120. Moreover, the network device 120 receives the first beam report on the resource allocated by the network device.

In some example embodiments, the network device 120 receives, from the terminal device 110, a second beam report of one or more transmit beams for the secondary cell, the second beam report being based on a refined receive beam of the terminal device 110; and transmits, to the terminal device 110, a second indication of at least one transmit beam for the secondary cell, the at least one transmit beam indicated by the second indication being determined based on the second beam report and used for scheduling of a second data transmission in the secondary cell.

In some example embodiments, the network device 120 avoids the scheduling of the first data transmission on a resource that is overlapping with a reference signal on which a measurement for the second beam report is to be performed.

In some example embodiments, an apparatus capable of performing the method 500 (for example, the terminal device 110) may comprise means for performing the respective steps of the method 500. The means may be implemented in any suitable form. For example, the means may be implemented in a circuitry or software module.

In some example embodiments, the apparatus comprises means for determining that a first data transmission in a secondary cell provided by a network device is possible during an activation procedure of the secondary cell; means for transmitting, to the network device, a first beam report of one or more transmit beams for the secondary cell; and means for receiving, from the network device, scheduling of the first data transmission in the secondary cell.

In some example embodiments, the apparatus further comprises means for performing a cell detection in the activation procedure of the secondary cell, and the means for transmitting the first beam report comprises means for in accordance with completing the cell detection, transmitting the first beam report.

In some example embodiments, the apparatus further comprises means for receiving, from the network device, a first indication of at least one transmit beam for the secondary cell, the at least one transmit beam being based on the first beam report and used for the scheduling of the first data transmission in the secondary cell; and means for receiving, from the network device in the secondary cell, the first data transmission based on the first indication during the activation procedure.

In some example embodiments, the apparatus further comprises means for monitoring the least one transmit beam indicated by the first indication for the scheduling of the first data transmission.

In some example embodiments, means for receiving the first data transmission comprises means for receiving the first data transmission using a non-refined receive beam of the terminal device.

In some example embodiments, the first beam report is obtained based on a non-refined receive beam of the terminal device.

In some example embodiments, the apparatus further comprises means for performing, a measurement based on a refined beam of the terminal device in parallel with the first data transmission; means for transmitting, to the network device, a second beam report of one or more transmit beams for the secondary cell, the second beam report being obtained based on the measurement; and means for receiving, from the network device, a second indication of at least one transmit beam for the secondary cell, the at least one transmit beam indicated by the second indication being based on the second beam report and used for scheduling of a second data transmission in the secondary cell.

In some example embodiments, the apparatus further comprises means for receiving a reference signal used for a channel measurement based on the at least one transmit beam indicated by the first indication; and means for performing the channel measurement in parallel with the measurement for the second beam report.

In some example embodiments, the means for transmitting the second beam report comprises means for, in accordance with a determination that the second beam report is different from the first beam report, or a difference between the first beam report and the second beam report is greater than a difference threshold, transmitting the second beam report.

In some example embodiments, the means for transmitting the second beam report comprises means for, in accordance with a determination that different transmit beams are to be determined based on the first beam report and the second beam report, transmitting the second beam report.

In some example embodiments, the means for transmitting the first beam report comprises means for, in accordance with a determination that a channel state information reference signal is not configured for the measurement for the second beam report, transmitting the first beam report.

In some example embodiments, the first data transmission is not scheduled on a resource that is overlapping with a reference signal on which the measurement for the second beam report is to be performed.

In some example embodiments, the means for transmitting the first beam report comprises means for, in accordance with a determination that a gain difference between a non-defined beam and a refined beam of the terminal device is within a margin threshold, transmitting the first beam report.

In some example embodiments, the means for transmitting the first beam report comprises means for, in accordance with a determination that at least one measurement result of the one or more transmit beams is higher than a threshold, transmitting the first beam report.

In some example embodiments, the means for transmitting the first beam report comprises means for, in accordance with having a valid radio resource management measurement result on the secondary cell, transmitting the first beam report in response to an activation command for the secondary cell.

In some example embodiments, the first beam report comprises one or more reference signal received power of the one or more transmit beams.

In some example embodiments, the first beam report is based on a measurement performed by the terminal device during the cell detection.

In some example embodiments, the first beam report is based on a measurement performed by the terminal device in a deactivated state of the secondary cell.

In some example embodiments, the first beam report is transmitted on a physical uplink control channel or a physical uplink shared channel configured for beam reporting.

In some example embodiments, the apparatus further comprises means for transmitting, to the network device, a request for allocating a resource for transmitting the first beam report; and means for receiving, from the network device, an indication of the resource allocated by the network device, and the means for transmitting the first beam report comprises means for transmitting the first beam report on the resource allocated by the network device.

In some embodiments, the apparatus further comprises means for performing other steps in some embodiments of the method 500. In some embodiments, the means comprises at least one processor and at least one memory including computer program code. The at least one memory and computer program code are configured to, with the at least one processor, cause the performance of the apparatus.

In some example embodiments, an apparatus capable of performing the method 600 (for example, the network device 120) may comprise means for performing the respective steps of the method 600. The means may be implemented in any suitable form. For example, the means may be implemented in a circuitry or software module.

In some example embodiments, the apparatus comprises means for receiving, from the terminal device, a first beam report of one or more transmit beams for a secondary cell provided by the network device; means for transmitting, to the terminal device, a first indication of at least one transmit beam for the secondary cell, the at least one transmit beam being determined based on the first beam report and used for scheduling of a first data transmission in the secondary cell; and means for transmitting, to the terminal device in the secondary cell, the first data transmission based on the scheduling of the first data transmission during an activation procedure of the secondary cell.

In some example embodiments, the apparatus further comprises means for transmitting, to the terminal device, the scheduling of the first data transmission using the least one transmit beam.

In some example embodiments, the means for transmitting the first data transmission comprises means for transmitting the first data transmission using the at least one transmit beam.

In some example embodiments, the apparatus further comprises means for transmitting a reference signal used for a channel measurement using the at least one transmit beam.

In some example embodiments, the first beam report comprises one or more reference signal received power of the one or more transmit beams.

In some example embodiments, the first beam report is received on a physical uplink control channel or a physical uplink shared channel configured for beam reporting.

In some example embodiments, the apparatus further comprises means for receiving, from the terminal, a request for allocating a resource for transmitting the first beam report, and means for transmitting, to the terminal device, an indication of a resource allocated by the network device, and the means for receiving the first beam report comprises means for receiving the first beam report on the resource allocated by the network device.

In some example embodiments, the apparatus further comprises means for receiving, from the terminal device, a second beam report of one or more transmit beams for the secondary cell, the second beam report being based on a refined receive beam of the terminal device; and means for transmitting, to the terminal device, a second indication of at least one transmit beam for the secondary cell, the at least one transmit beam indicated by the second indication being determined based on the second beam report and used for scheduling of a second data transmission in the secondary cell.

In some example embodiments, the apparatus further comprises means for avoiding the scheduling of the first data transmission on a resource that is overlapping with a reference signal on which a measurement for the second beam report is to be performed.

In some embodiments, the apparatus further comprises means for performing other steps in some embodiments of the method 600. In some embodiments, the means comprises at least one processor and at least one memory including computer program code. The at least one memory and computer program code are configured to, with the at least one processor, cause the performance of the apparatus.

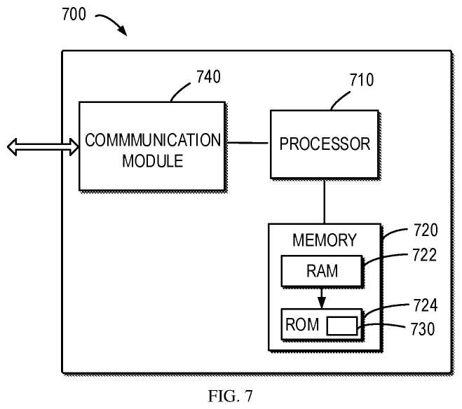

FIG. 7 illustrates a simplified block diagram of a device 700 that is suitable for implementing some example embodiments of the present disclosure. The device 700 may be provided to implement the communication device, for example, the terminal device 110, or the network device 120 as shown in FIG. 1A. As shown, the device 700 includes one or more processors 710, one or more memories 720 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 2 to 6. The embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like.

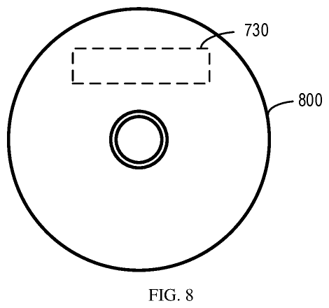

FIG. 8 illustrates a block diagram of an example of a computer readable medium 800 in accordance with some example embodiments of the present disclosure. The computer readable medium 800 has the program 730 stored thereon. It is noted that although the computer readable medium 800 is depicted in form of CD or DVD in FIG. 8, the computer readable medium 800 may be in any other form suitable for carry or hold the program 730.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to any of FIGS. 5-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-34. (canceled)

35. A terminal device comprising:
at least one processor; and
at least one memory storing instructions that, when executed by the at least one processor, cause the terminal device at least to:
determine that a first data transmission in a secondary cell provided by a network device is possible during an activation procedure of the secondary cell;
transmit, to the network device, a first beam report of one or more transmit beams for the secondary cell; and
receive, from the network device, scheduling of the first data transmission in the secondary cell.

36. The terminal device of claim 35, wherein the terminal device is further caused to:
perform a cell detection in the activation procedure of the secondary cell, and wherein the terminal device is further caused to transmit the first beam report by:
in accordance with completing the cell detection, transmitting the first beam report.

37. The terminal device of claim 35, wherein the terminal device is further caused to:
receive, from the network device, a first indication of at least one transmit beam for the secondary cell, the at least one transmit beam being based on the first beam report and used for the scheduling of the first data transmission in the secondary cell; and
receive, from the network device in the secondary cell, the first data transmission based on the first indication during the activation procedure.

38. The terminal device of claim 37, wherein the terminal device is further caused to:
monitor the least one transmit beam indicated by the first indication for the scheduling of the first data transmission.

39. The terminal device of claim 37, wherein the terminal device is caused to receive the first data transmission by:
receiving the first data transmission using a non-refined receive beam of the terminal device.

40. The terminal device of claim 35, wherein the first beam report is obtained based on a non-refined receive beam of the terminal device.

41. The terminal device of claim 35, wherein the terminal device is further caused to:
perform a measurement based on a refined beam of the terminal device in parallel with the first data transmission;
transmit, to the network device, a second beam report of one or more transmit beams for the secondary cell, the second beam report being obtained based on the measurement; and
receive, from the network device, a second indication of at least one transmit beam for the secondary cell, the at least one transmit beam indicated by the second indication being based on the second beam report and used for scheduling of a second data transmission in the secondary cell.

42. The terminal device of claim 41, wherein the terminal device is further caused to:
receive a reference signal used for a channel measurement based on the at least one transmit beam indicated by the first indication; and
perform the channel measurement in parallel with the measurement for the second beam report.

43. The terminal device of claim 41, wherein the terminal device is caused to transmit the second beam report by:
in accordance with a determination that the second beam report is different from the first beam report, or a difference between the first beam report and the second beam report is greater than a difference threshold, transmitting the second beam report.

44. The terminal device of claim 41, wherein the terminal device is caused to transmit the second beam report by:
in accordance with a determination that different transmit beams are to be determined based on the first beam report and the second beam report, transmitting the second beam report.

45. The terminal device of claim 41, wherein the terminal device is caused to transmit the first beam report by:
in accordance with a determination that a channel state information reference signal is not configured for the measurement for the second beam report, transmitting the first beam report.

46. The terminal device of claim 41, wherein the first data transmission is not scheduled on a resource that is overlapping with a reference signal on which the measurement for the second beam report is to be performed.

47. The terminal device of claim 35, wherein the terminal device is caused to transmit the first beam report by:
in accordance with a determination that a gain difference between a non-defined beam and a refined beam of the terminal device is within a margin threshold, transmitting the first beam report.

48. The terminal device of claim 35, wherein the terminal device is caused to transmit the first beam report by:
in accordance with a determination that at least one measurement result of the one or more transmit beams is higher than a threshold, transmitting the first beam report.

49. The terminal device of claim 35, wherein the terminal device is caused to transmit the first beam report by:
in accordance with having a valid radio resource management measurement result on the secondary cell, transmitting the first beam report in response to an activation command for the secondary cell.

50. The terminal device of claim 35, wherein at least one of:
the first beam report comprises one or more reference signal received power of the one or more transmit beams, or
the first beam report is based on a measurement performed by the terminal device during the cell detection, or
the first beam report is based on a measurement performed by the terminal device in a deactivated state of the secondary cell, or
the first beam report is transmitted on a physical uplink control channel or a physical uplink shared channel configured for beam reporting.

51. The terminal device of claim 35, wherein the terminal device is further caused to: transmit, to the network device, a request for allocating a resource for transmitting the first beam report; and
receive, from the network device, an indication of the resource allocated by the network device, and
wherein the terminal device is caused to transmit the first beam report by:
transmitting the first beam report on the resource allocated by the network device.

52. A network device comprising:
at least one processor; and
at least one memory storing instructions that, when executed by the at least one processor, cause the network device at least to:
receive, from the terminal device, a first beam report of one or more transmit beams for a secondary cell provided by the network device;
transmit, to the terminal device, a first indication of at least one transmit beam for the secondary cell, the at least one transmit beam being determined based on the first beam report and used for scheduling of a first data transmission in the secondary cell; and
transmit, to the terminal device in the secondary cell, the first data transmission based on the scheduling of the first data transmission during an activation procedure of the secondary cell.

53. The network device of claim 52, wherein the network device is further caused to:
transmit, to the terminal device, the scheduling of the first data transmission using the least one transmit beam.

54. An apparatus comprising:
means for determining, at a terminal device, that a first data transmission in a secondary cell provided by a network device is possible during an activation procedure of the secondary cell;
means for transmitting, to the network device, a first beam report of one or more transmit beams for the secondary cell; and
means for receiving, from the network device, scheduling of the first data transmission in the secondary cell.
